(19) United States
(12) Patent Application Publication
(10) Pub. No.: US 2025/0350884 A1
(43) Pub. Date: Nov. 13, 2025

(54) AUDIO CONTROL FOR LIVE STREAMING

(71) Applicant: Michael John Ross, Los Angeles, CA (US)

(72) Inventor: Michael John Ross, Los Angeles, CA (US)

(21) Appl. No.: 18/661,571

(22) Filed: May 11, 2024

(51) Int. Cl. H04R 3/04; G06F 3/16

(52) U.S. Cl. CPC H04R 3/04; G06F 3/165

(57) ABSTRACT

A DCP server for use with a cinema processor for playing high quality live streaming content from a venue, such as a concert, and distributing it for playing in a movie theater is disclosed. The DCP server automatically adjusts the volume and the equalization outputs of the speakers in the movie theater to the industry standard and controls the volume setting of the cinema processor.

### TECHNICAL FIELD

The invention pertains to systems for creating and distributing high quality live streaming content from a performance venue, such as a concert, to the final consumer, such as at movie theaters across various platforms. It involves apparatus and methods for automatically adjusting and controlling the volume and quality of the audio heard through the multiple speakers in the theater.

### BACKGROUND

The realm of content creation and distribution has seen significant advancements over the years. One of the key areas of focus has been the distribution of high quality audio and video streaming content from concerts and other types of live performances at venues such as theaters, stadiums and arenas to the final consumer, typically at a movie theater.

In the context of motion picture distribution, the prevalent current method involves the creation of a large digital file containing the audio mix and video for the movie that is stored in a digital control processor server (DCP server). This file can be delivered to the DCP server in the movie theater either on physical media such as a hard drive or via the internet. The DCP server is not capable of playing streaming content. In the movie theater there are a few components that make up a ‘DCP Package’, they are;
1) A Digital Control Processor (“DCP”) Server. This is the device that plays the movie file;
2) A Cinema Processor. This device receives the audio components from the movie, and it in turn controls the overall volume in the theater as well as individual speaker volumes and equalization (EQ) presets, it also does the relevant audio format conversions such as Atmos, 7.1, 5.1;
3) A Projector. This device receives the video signal from the DCP Server and projects the image onto the screen; and.
4) A KDM key. This key is transmitted with the file and is embedded with the serial number of the DCP Server and will only play the movie file at the time specified in the key as well as on the specific equipment defined in the key.

The DCP server also has some automation capabilities that are used to control theater light dimming, screen curtain opening, movie playback, start and stop, as well as other unique requests that a theater might have. Dolby cinema processing systems, such as the Dolby CP 750, 850 or 950 systems, are used in a large part of the existing movie theaters.

The DCP server separates the audio and video portions of the file and transmits the video signal to the projector which displays the video on the movie screen in the movie theater. The cinema processor takes the audio output from the DCP server and converts the resulting audio into whatever format that particular theater is capable of reproducing, typically 5.1, 7.1 or Dolby Atmos, for play through the multiple speakers in the movie theater. The speakers are operated by amplifiers, not shown.

The cinema processor controls the volume of the movie theater speakers. The cinema processor has a volume control, both a physical knob and through Ethernet control, that permits the speaker volume to be manually set to the desired volume level. The recognized industry standard for the volume level of the speakers in a movie theaters is 85 db, corresponding to a volume setting of “7” on the cinema processor. The director or person in charge of mixing the audio of the movie typically will mix the audio of the movie so that the audio is heard in the movie theater at the optimum volume of 85 db to assure that the dialog and music has the intended effect. However, due to the extreme high volume dynamics that some motion pictures are mixed at, and due to fear of complaints from patrons that the volume of the speakers are too high, it has become common practice for the operators of the movie theater to set the volume of the speakers when running the motion pictures well below the standard of 85 db, setting “7” on the volume control. In fact, due to concerns over the liability from the audio being too high, DCP streamers would ordinarily not want to control the volume of the audio.

Accordingly, rarely does a movie get played at 85 db, resulting in dialogue levels being hard to hear and the sound of the music being muted, diminishing the listening experience of the patron.

Also, the quality of the output of the many speakers in movie theaters is dependent on the calibration of the theater's speakers located around the theater. The calibration of the speakers is initially performed at the time the movie theater is initially being opened by sound technicians going to the theater and calibrating each of the individual speakers to the industry standard which is an 85 db volume level when being fed pink noise at a −20 db reference level on most speakers, depending on the format. For example surround speakers can be set to 82 db. The other measurement of importance is the industry standard frequency response from each speaker, referred to as the X curve. This is a flat frequency response up to 2 khz and then a 2 db per octave roll off until 20 khz.

The speakers are supposed to be recalibrated by the technicians on a regular basis since the speakers periodically get out of calibration, due to use and aging, so that the output volume of the speakers to a “7” setting on the cinema processor no longer is 85 db and there is no longer the proper X curve. The lack of the proper volume and calibration of the X curve of the speakers, can significantly impact the quality of the audio being heard in the movie theater. However, due to the cost and unavailability of the technicians required to calibrate the speakers, the speakers are typically not regularly recalibrated as they should be.

### SUMMARY OF THE INVENTION

The system of the present invention is primarily intended for use in “live streaming” of the video and audio mix from live concerts to venues, such as movie theaters, that have complete video and audio playback capabilities. For live concerts, the video and audio mix of the live concert are captured and processed for audio mixing and picture formatting in real-time, and then streamed to movie theaters via any suitable CDN (content distribution network) or the cloud. The concert is also recorded and available for later distribution to account for various time zones. The patrons attending the streaming of a concert event at a movie theater are very discerning patrons and expect the volume and quality of the audio played through the speakers at the movie theater to have the optimum volume and quality.

As with the sound mix for a movie, the sound mix of the streaming of the live concert would typically be expected to be played back in the movie theater through the speakers at 85 db or a “7” setting. The streaming DCP server of the present invention receives the digital audio mix and video file of the concert from the CDN or cloud, instead of the conventional DCP server. The existing DCP server remains in the movie theater and is used exactly as it always was used, namely for playing movies. The streaming DCP server device acts the same as the existing DCP server in that it replaces the existing DCP server while streaming the live concert file and performs the same functions as the existing DCP server. It splits out the audio mix from the video signal and sends the video signal to the projector. The audio mix signal is sent to the cinema processor. The projector and cinema processor operate in the same manner as if it had received the signal from the standard DCP server. As with the existing standard DCP server, the streaming DCP server is capable of controlling the light dimming, start and stop times and the other operations of the DCP in the movie theater.

However, unlike the existing DCP server, the streaming DCP server of the present invention has software and hardware so that it is capable of receiving a digital data stream, and adjusting the audio mix signal of the digital data stream to compensate for any of the speakers being out of calibration from the industry standard volume and X curve. The adjusted audio signal is transmitted to the cinema processor. The compensation for the errors in equalization and volume that have occurred over time are corrected without having to go into the internal calibration of the cinema processor.

The streaming DCP server generates a tonal sweep followed by pink noise sequentially for each channel being fed into each of the speakers and amplifiers through the cinema processor. Four MEMS microphones are placed in the movie theater in a line two thirds of the distance away from the front screen. These microphones pick up the tonal sweep and pink noise as played by each speaker for each channel and feeds this information back to the streaming DCP server via Wi-Fi, where adjustments are made in volume level and equalization X curve by an audio calibration module that automatically adjusts the X curve and volume to the industry standard and transmits this adjusted audio signal to the cinema processor so as to compensate for whatever irregularities are present in the audio system. The audio calibration module can be either hardware or software.

Once the required settings are achieved, and the speakers in the movie theater are now recalibrated to the industry standard the streaming DCP server sends a volume command signal to the volume setting control of the cinema processor to set the cinema processor master level setting at “7”, corresponding to 85 db. The volume command signal is sent constantly, or at very short intervals, to the cinema processor during the playing of the audio file in order to prevent any local intervention and manipulation of the volume setting by the operator at the movie theater. If there is an attempt to change the volume setting of the cinema processor at the theater by an operator, as soon as the volume control is released, the volume control signal resets the volume to setting “7”. Since the X curve and the output volume of the speakers in the movie theater receives are controlled and the volume setting of the cinema processor is always set to the “7” setting, it can be assured that the live streaming performances experienced by the patrons in the movie theater will be the best quality and volume, something not previously possible.

### OBJECTS OF THE PRESENT INVENTION

It is an object of the present invention, to provide an apparatus to provide the optimum quality output of speakers in a venue, such as a movie theater, for the streaming of a live concert;

It is another object of the present invention to provide apparatus to automatically recalibrate the equalization X curve of the speakers in a venue, such as a movie theater, to the industry standard;

It is another object of the present invention to provide apparatus to automatically adjust the volume of the speakers in a venue, such as a movie theater;

It is still another object of the present invention to provide apparatus for automatically controlling the volume setting of a cinema processor in a movie theater to a preselected setting;

It is another object of the present invention to provide apparatus that is easily integrated into the existing equipment package used in movie theaters for controlling the audio; and

It is yet another object of the present invention to provide an improved DCP server for streaming digital files in a movie theater;

These and other objects of the president invention will be evident from review of the accompanying specification and drawings.

### BRIEF DESCRIPTION OF THE DRAWINGS

FIG. 1 is a block diagram showing the components of the video and audio apparatus for playing a prerecorded movie and for the streaming of a live concert in a movie theater.

FIG. 2 is a block diagram of the steaming DCP of the present invention.

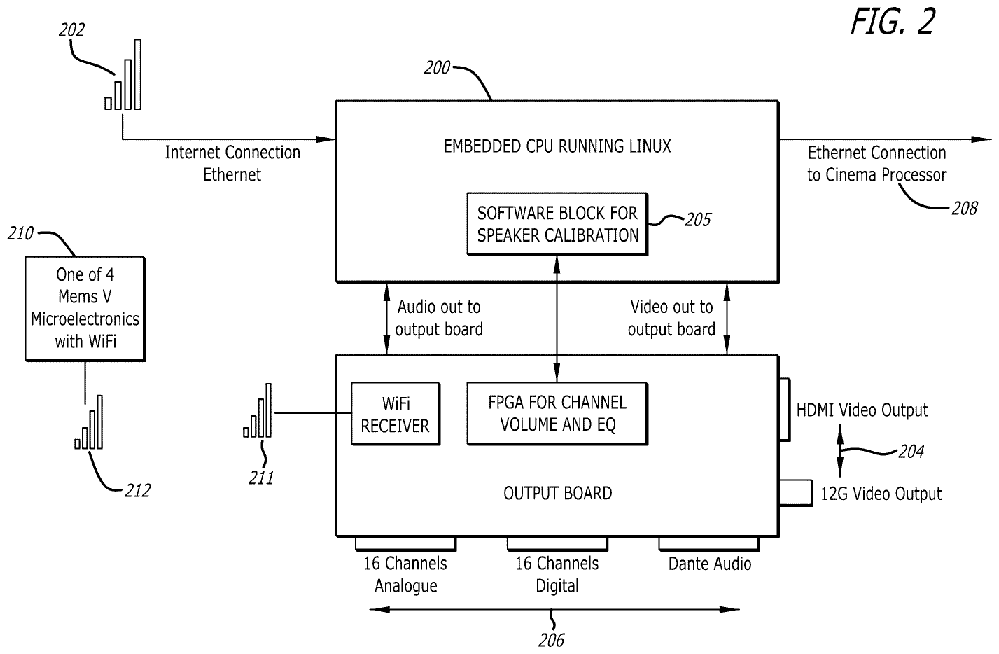

FIG. 3A shows the industry standard X curve.

FIG. 3B shows an X curve with errors in the frequency response.

FIG. 3C shows the X curve with errors in both the frequency response and volume.

FIG. 3D shows the compensation curve to adjust for the errors to the frequency response shown in FIG. 3C.

FIG. 3E shows the compensation curve to adjust for the errors to the frequency response and volume shown in FIG. 3C.

FIG. 4 shows the front panel of the housing of the streaming DCP server of the present invention; and

### DETAILED DESCRIPTION OF THE DRAWINGS

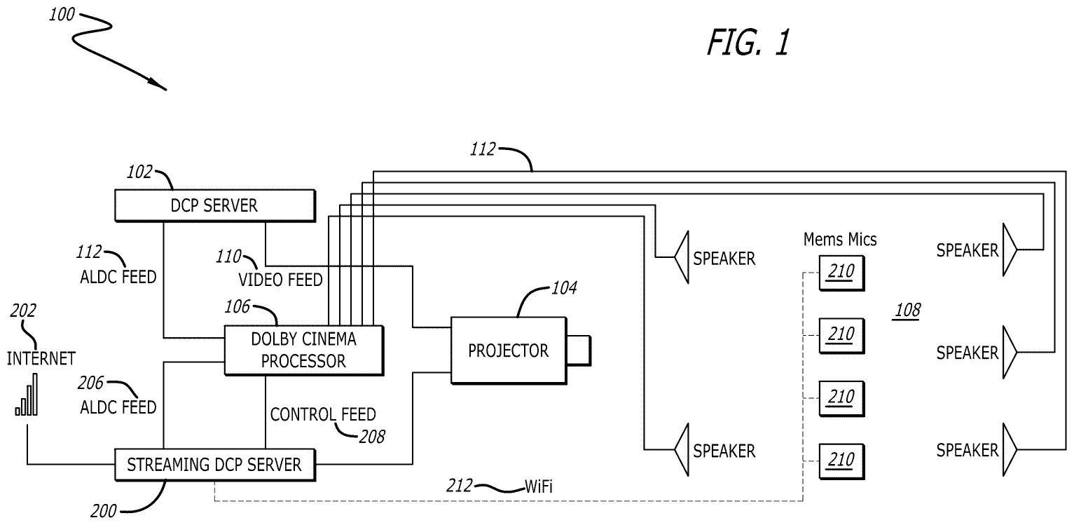

Referring to FIG. 1, the connection of the streaming digital cinema processor 200 of the present invention is shown incorporated into the video and audio apparatus, including the DCP server typically used for playing a movie in a movie theater 100. The movie theater 100 includes a video screen, not shown, a conventional DCP server 102 for playing a movie stored on the DCP server 102, a projector 104, a cinema processor 106 and a plurality of speakers 108 connected to the cinema processor 106. The speaker has an associated amplifier, not shown. The movie may be delivered to the DCP server 102 via the Internet or a hard drive. The DCP server 102 splits the stored movie file into video 110 and audio 112 outputs. A KDM key (not shown) must match the serial number of the DCP server 102 in order for the movie to be played.

The audio output 112 from the DCP server 102 is connected to the cinema processor 106. The cinema processor 106 controls the overall volume of the individual speakers 108 and the equalization (EQ) curve, as well as the relevant audio format conversions, such as Atmos, 7.1, 5.1.

Cinema processor 106 includes volume controls which can be physical knobs and/or electrical controls. The volume control on the cinema processor 106 typically uses numerals to show the volume settings. The audio setting of the cinema processor 106 can be set, either manually or remotely via Ethernet. The numbers range from 1-10. The volume setting “7” on the cinema processor 106 typically corresponds to the speakers 108 playing back the audio at 85 db. The audio outputs 112 of the cinema processor 106 are connected to the various speakers 108 located around the movie theater 100. A plurality of MEMS microphones 210, preferably four, are connected to the streaming DCP serve 200 via Wi-Fi.

The streaming DCP server 200 is also connected to the cinema processor 106 and receives via the internet 202 a digital stream of the audio mix of the live concert that is stored in the CDN or cloud or other network distribution system. In the preferred embodiment the Amazon Web Services (AWS) is used. While the live concert file can be shown in the movie theater contemporaneously with the performance of the live concert, it can be accessed any time from the CDN or cloud.

The streaming DCP server 200 splits the digital file into a video output 204 and audio outputs 206 for each audio channel of the mix. The video output 204 of the streaming DCP server 200 is transmitted to the projector 104. The audio outputs 206, after the equalization (EQ) curve and the volume of the individual speakers are adjusted, as described below by the audio calibration module, is transmitted to the cinema processor 106. The cinema processor 106 in turn transmits the audio output 112 to the various speakers 108. The streaming DCP server 200 transmits a volume control signal 208 to the cinema processor 106, setting the volume control of the cinema processor 106 to the “7” setting, corresponding to 85 db output from the speakers 108.

The streaming DCP server 200 consists of embedded computer components, including a CPU 202, that runs software that controls hardware that allows the streaming DCP server 200 to output multichannel audio and high-quality video. The audio output 204 uses AES/EBU, analogue, and also Dante and the video output 206 uses a 12 g connection and HDMI.

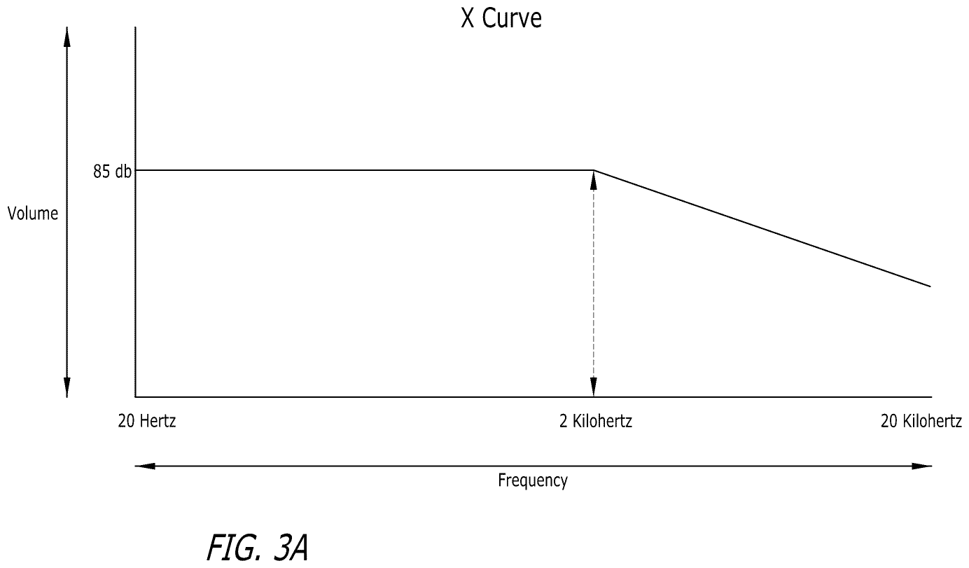

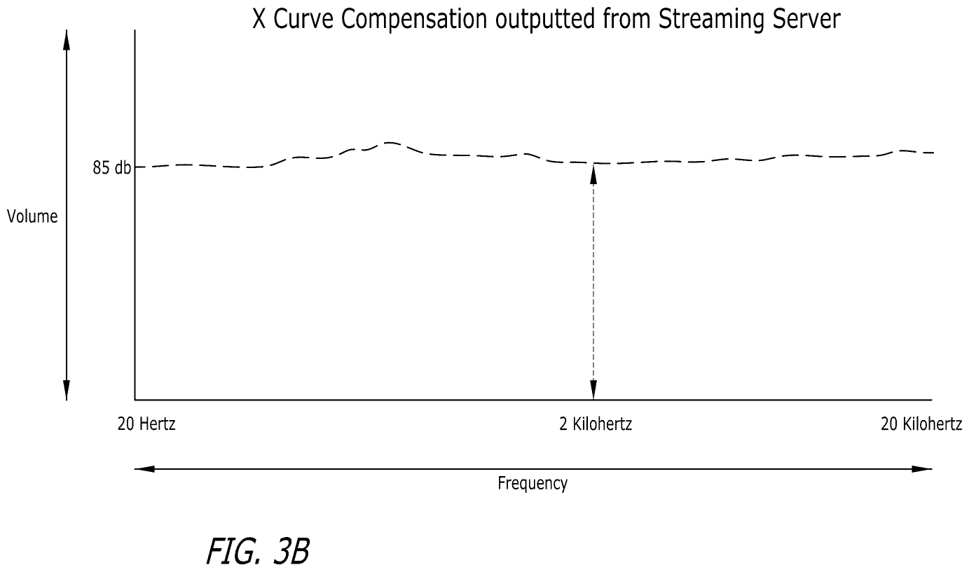

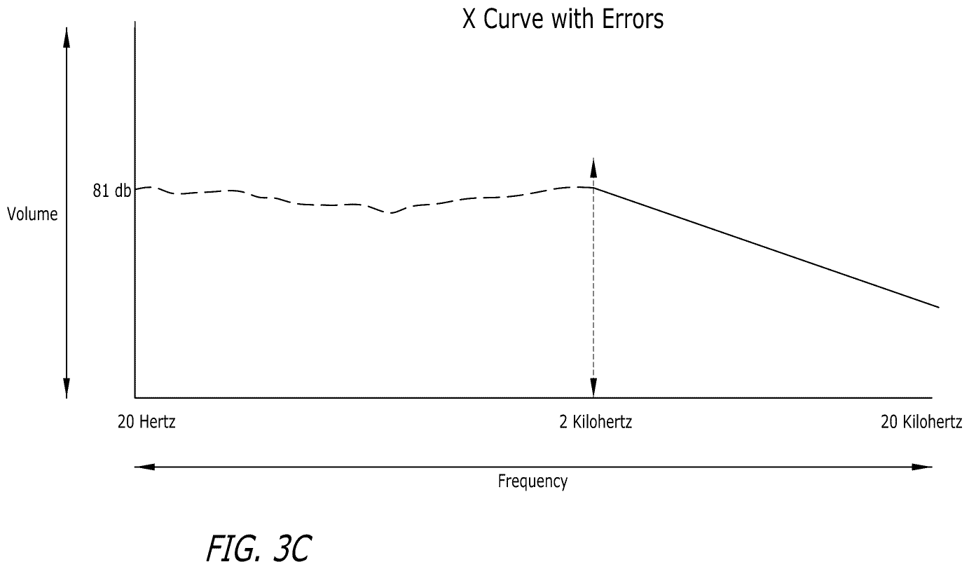

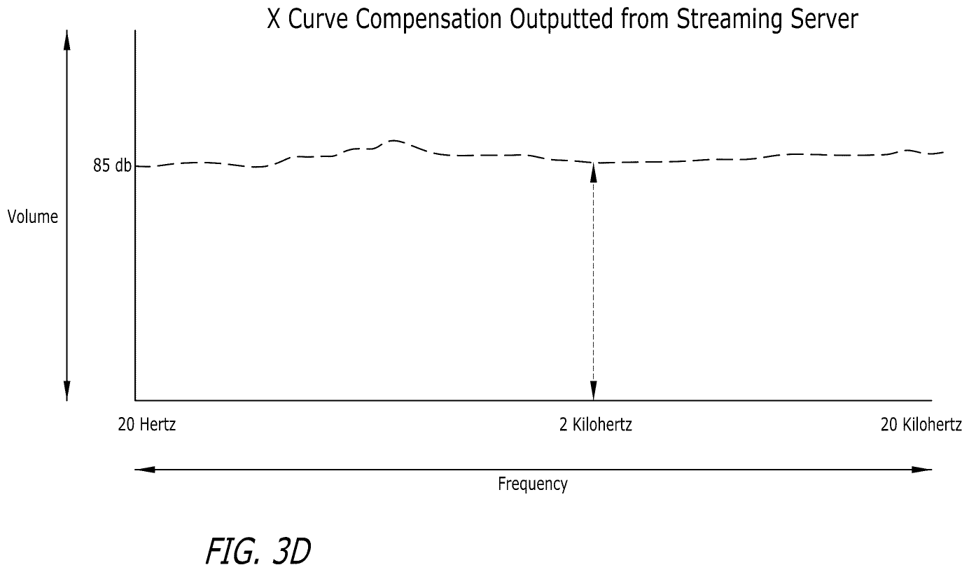

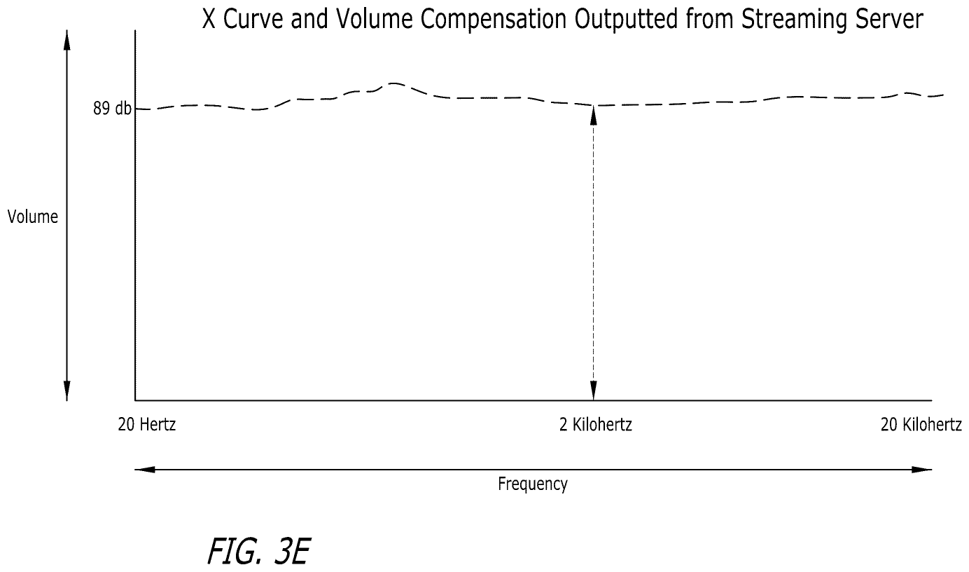

The embedded software and hardware facilitates the adjustment of the audio output of the streaming DCP server 200 in response to information regarding the frequency response and volume of the speakers 108 gathered using the MEMS microphones 210 in the movie theater so that the speakers 108 generate an X curve as shown in FIG. 3A.

Ethernet connections on the streaming DCP server 200 are used to interface with the internet and also send control information to the cinema processor.

The streaming DCP server 200 operates as follows: The streaming DCP server 200 is connected to the projector 104 and the cinema processor 106 in the same way as the existing DCP server 102 is connected to the cinema processor 106 and projector 104. The MEMS microphones 210 are attached to the back of the seats in the movie theater in locations as described above. The streaming DCP server 200 generates pink noise and sweep tone signals to each of the speakers 108 sequentially through the cinema processor 106 so that each individual speaker 108 has its equalization curve and its volume level transmitted by the MEMS microphones 210 via Wi-Fi 212 to the streaming DCP server 200 via Wi-Fi receiver 211 to adjust the X curve and adjust the speaker 108 volume to 85 db. An example of an erroneous curve is shown in FIG. 3B.

The audio calibration module 202 compares the frequency curve received from the MEMS microphone 210 (FIG. 3B) with the industry standard X curve (FIG. 3A) and adjusts the audio output 204 to the cinema processor 106 via Ethernet connection 208 of a frequency response curve, an example of which is shown in FIG. 3D, that is complimentary to the erroneous frequency curve (FIG. 3B) so that the audio output of the steaming DCP server 200 transmitted to the cinema processor 106 results in the output of the cinema processor 106 sending a signal to the speakers 108 so that the frequency response from the speakers 108 is an industry standard X curve (FIG. 3A). The audio calibration module 202 either raises or lowers the frequency response received from the MEMS microphones 210 so as to match the industry standard X curve. For example, if the frequency response of the speakers 108 received by the streaming DCP server 200 in response to the generated pink noise shows that the frequency response is 2 db below the industry standard (83 db) at a particular frequency, the audio calibrating module of the streaming DCP server 200 will adjust the frequency response sent to the cinema processor 106 by increasing the frequency signal by 4 db so as to be 2 db above the industry standard. (87 db). Automatic calibration of frequency curves are known, including from Sonar Works. The programming of the audio calibration module 202 to automatically adjust the frequency response can be done by one of ordinary skill in the art.

Also, the audio calibration module 202 receives the volume of the speakers 108 from the MEMS microphone 210 (FIG. 3B), and either raises or lowers the volume level of each individual speaker 108 so the output of the cinema processor 106 will cause the speaker 108 to have the desired volume, which in the case of streaming of a live concert in a movie theater would be 85 db. For example, if, as shown in FIG. 3C, the volume level received is 81 db, rather than 85 db, as in the case of the adjustment of the frequency curve when the frequency curve was too low, for example, if the volume speaker is 81 db, 4 db too low, the audio calibration module will increase the volume of the signal sent to the cinema processor (FIG. 3E) by 5 db to 89 db so that the output of the cinema processor will result in the speaker 108 resulting in a volume of 85 db.

At the same time that the adjusted audio signal is sent via Ethernet connection 208 to the audio input of the cinema processor 106, the streaming DCP server 200 transmits a signal to the volume setting control of the cinema processor 106 to set the volume setting control of the cinema processor 106 to a “7” setting. The streaming DCP server 200 sends constantly, and in the preferred embodiment at least every 10 milliseconds a signal to the volume setting control of the cinema processor 106 corresponding to the “7” setting. The volume control signal is sent frequently enough so that if the volume setting of the cinema processor 1106 is changed by the operator of the movie theater, the volume setting will be returned to the “7” setting fast enough so that the patrons in the movie theater will not notice that the volume of the speakers has changed,

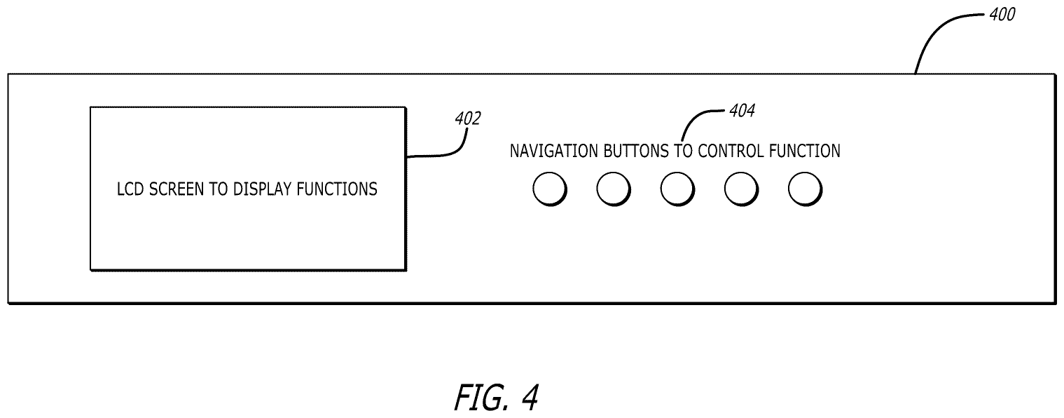

Referring to FIG. 4, the front panel 400 of the housing for the streaming DCP server 200 is shown. The front panel 400 includes a TFT display 402 and a row of push button controls 404 for navigating through the various menus of the streaming DCP server 200. The TFT display 402 is used for basic set up and monitoring of the status of the streaming DCP server 200. The TFT display 402 would show for example, the IP addresses and the health status of the streaming DCP server 200. Once these basic parameters are set, more extensive controls are possible via browser.

While the steaming DCP server 200 has been described as being used in parallel with a standard DCP server 102 for playing prerecorded movies, it is possible for the components of the streaming DCP server 200 for adjusting the volume and the frequency response of the speakers 108 and controlling the volume setting of the cinema processor 106 could be incorporated into the DCP server 102 so that there would be one DCP server capable of both streaming and playing a movie. Such a DCP server would include the capability of adjusting the volume and frequency response of the speakers for both streaming and playing a movie. When playing a standard movie, to accommodate the operators of the movie theater who do not want the volume setting of the cinema processor 106 to be constantly set to the “7” setting the automatic volume control signal from the DCP server would only be sent to the cinema processor 106 when such a DCP server is in its steaming mode of operation. The operator of the movie theater will still have control of the volume setting of the cinema processor 106 when playing a movie.

While the preferred and alternative embodiments have been disclosed, other embodiments can be used without departing from the inventive concept disclosed. For example, while the description has described the invention in use with a cinema processor in a move theater, the invention can be employed in other venues, such as in homes or concert halls. Also, while the invention has been described in use with a file containing video, the invention can also be used for files do not contain video, but audio only, such as the performance of an orchestra.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein, but is to be accorded the widest scope consistent with the principles and novel features disclosed herein. The following goes at the end of the current detailed description of the invention.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What I claim is:

1. A digital control processor for use in playing an audio file by means of a cinema processor connected to at least one speaker, said speaker generating an output in response to an audio signal from said cinema controller comprising:
an audio calibration module for receiving the frequency response curve of the output of said speaker;
said audio calibration module capable of comparing said frequency response curve of said speaker to a predetermined frequency response curve stored in said audio calibration module; and
said audio calibration module automatically generating an output signal to said cinema processor that adjusts the audio output signal of the cinema controller to said speaker so that the output of the speaker matches the frequency response of the predetermined frequency response.

2. The digital control processor of claim 1 in which the predetermined frequency response is an X curve.

3. The digital control processor of claim 1, in which said audio calibration module automatically compares the volume of said frequency response from said speaker to a predetermined volume and adjusts the volume of said speaker so that the volume of said speaker is the predetermined volume.

4. The digital control processor of claim 3 in which said predetermined volume is 85 db.

5. The digital control processor of claim 1 having programming to be able to play a streaming audio file.

6. The digital control processor of claim 1 including a Wi-Fi receiver and at least one microphone receives the frequency response of said speaker and said frequency response is received via Wi-Fi be said digital control processor.

7. A digital control processor for use in playing an audio file by means of a cinema processor connected to at least one speaker, said speaker generating an output in response to an audio signal from said cinema controller comprising:
an audio calibration module for receiving the frequency response curve of the output of said speaker;
said audio calibration module capable of comparing the volume of said frequency response curve of said speaker to a predetermined volume stored in said audio calibration module; and
said audio calibration module automatically generating an output signal that adjusts the audio output signal of the cinema controller to said speaker so that the output of said speaker is the predetermined volume.

8. The digital control processor of claim 7 in which the predetermined volume of the frequency response curve is 85 db.

9. The digital control processor of claim 7, in which said audio calibration module automatically compares the volume of said frequency response curve from said speaker to a predetermined volume and transmits a signal to said cinema controller that adjusts the volume of the frequency response curve of said speaker so that the volume of the output frequency response curve of said speaker is 85 db.

10. The digital control processor of claim 7 having programming to be able to play a streaming audio file.

11. The digital control processor of claim 7 including a Wi-Fi receiver and at least one microphone receives the frequency response of the output of said speaker and said frequency response is received via Wi-Fi by said digital control processor.

12. A digital control processor for use in playing a streaming audio file by means of a cinema processor having a volume control, said digital control processor comprising:
programming to transmit a signal to said cinema processor setting the volume of said cinema control to a predetermined setting.

13. The digital control processor of claim 12, in which said predetermined setting is 85 db.

14. The digital control processor of claim 12, in which said predetermined setting is the “7” setting.

15. The digital control processor of claim 12 in which said signal is sent constantly.

16. The digital control processor of claim 12 in which said signal is sent to said cinema processor repeatedly at least every 10 milliseconds.

17. A method of automatically calibrating the frequency response curve and volume of the audio output of speakers in a venue by a digital control processor connected to a cinema processor having a volume control and connected to microphones located in said venue said digital control processor having an audio calibration module comprising the steps of:
said digital control processor causing said cinema processor to generate a sweep tone and X curve sequentially to each of said speakers;
said microphone transmitting the frequency response curve and volume output signal of said speakers to said digital control processor;
said digital control processor automatically comparing the frequency curve received to an X curve;
comparing the volume to 85 db;
generating an output signal to said cinema controller, said signal adjusting the output signal of said cinema processor so that the output signal to said speaker results in the output of said speakers; and
having an X curve frequency response curve and a volume of 85 db.

18. The method of claim 17 in which said digital control processor transmits a signal to said volume control, setting the volume control to 85 db.

19. The method of claim 18 in which said signal is sent constantly.

20. The method of claim 18 in which said signal is sent repeatedly, at last every 10 milliseconds.

21. A method of controlling the volume setting of a cinema processor connected to a digital control processor comprising the steps of said digital control processor generating a signal corresponding to the signal for setting the cinema controller to 85 db; and
transmitting said signal to said cinema controller whereby said volume setting of said cinema controller is set to a setting corresponding to 85 db.

22. The method of claim 21 in which said signal is sent constantly.

23. The method of claim 21 in which said signal is sent repeatedly, at last every 10 milli-seconds.
